(19) United States
(12) Patent Application Publication
(10) Pub. No.: US 2019/0010825 A1
(43) Pub. Date: Jan. 10, 2019

(54) BLADE-DISC ARRANGEMENT FOR A TURBOMACHINE

(71) Applicant: MTU Aero Engines AG, Munich (DE)

(72) Inventor: Alexander Kloetzer, Fuerstenfeldbruck (DE)

(73) Assignee: MTU Aero Engines AG, Munich (DE)

(21) Appl. No.: 16/027,635

(22) Filed: Jul. 5, 2018

(30) Foreign Application Priority Data
Jul. 7, 2017 (DE) 10 2017 211 646.3

(51) Int. Cl. F01D 25/08

(52) U.S. Cl. CPC F01D 25/08; F05D 2220/323; F05D 2300/2118; F05D 2260/231; F05D 2240/30

(57) ABSTRACT

The present invention relates to a blade-disc arrangement for a turbomachine having a disc and a plurality of grooves that are arranged in a casing surface of the disc for taking up blades, as well as a plurality of blades with blade roots that are accommodated in the grooves, wherein at least one heat shield element is arranged between at least one blade root and a groove surface of at least one groove, so that there is no direct contact between blade root and disc in the groove region, wherein the heat shield element is formed of a ceramic material, at least in part.

### BACKGROUND OF THE INVENTION

The present invention relates to a blade-disc arrangement for a turbomachine, such as, for example, a stationary gas turbine or an aircraft engine. Such blade-disc arrangements have a disc and a plurality of blades that are arranged on the casing surface of the disc. For this purpose, the disc has a plurality of grooves in the casing surface of the disc, in which the blades can be fastened by their blade roots.

In turbomachines, such as stationary gas turbines or aircraft engines, the fluid that flows through is propelled or compressed by blades rotating about an axis of rotation, or the fluid that flows through, by interacting with rotatable blades, propels the blades to rotate about an axis of rotation. For this purpose, turbomachines contain a plurality of blades that are arranged on rotating discs. In order to connect the blades with corresponding rotating discs, blade-disc arrangements are known, in which a plurality of grooves are formed in the casing surface of the respective disc, into which the blades can be inserted by their respective blade roots. Examples of this are found in EP 3 000 967 A2, US 2016/0341052 A1, US 2015/0322806 A1 and US 2016/0040539 A1.

In the blade-disc arrangement of US 2016/0341052 A1, different shims are arranged between parts of the groove surface and the blade root in order to prevent wear, whereas in US 2016/0040539 A1, a shroud element with an intermediate layer is provided between groove surface and blade root. US 2015/0322806 A1 describes an elastically deformable spring arrangement for the arrangement of ceramic matrix composite blades in metal discs. Finally, in EP 3 000 967 A2, a heat shield is arranged underneath the blade root in a supply channel for cooling air in the groove of the disc, in order to reduce the cooling effect of the cooling air on the rotating disc.

Of course, the problem that the temperature load of the discs also increases further along with increasing operating temperatures can only be solved inadequately by this arrangement. However, in order to be able to further increase the operating temperature of the turbomachine and thereby also to be able to increase the efficiency of turbomachines, it is necessary, of course, to find other solutions for high operating temperatures in the field of blade-disc arrangements.

### SUMMARY OF THE INVENTION

It is therefore the object of the present invention to provide a blade-disc arrangement that makes it possible to permit higher fluid temperatures in the turbomachine in order to increase the efficiency of the turbomachine. At the same time, however, the solution shall be easily implemented and shall not adversely affect the operation of the turbomachine.

This object is solved by a blade-disc arrangement having the features of claim 1. Advantageous embodiments are the subject of the dependent claims.

For reducing the temperature load of discs in blade-disc arrangements of turbomachines, the invention proposes that at least one heat shield element is arranged between a root of a blade and the surface of a groove in the disc, in order that there is no direct contact between blade root and disc in the groove region, so that a direct heat transfer from the blade root into the disc cannot occur. Instead of this, the heat conduction from the blade root into the disc can be controlled via the heat shield element. The invention further proposes that the heat shield element is formed of a ceramic material, at least in part. This has the advantage that a temperature gradient can be adjusted between blade root and disc by way of a ceramic material with lower heat conductivity. In addition, ceramic materials fulfill in a good way the requirements during operation in the region between blade root and disc where high pressures and high temperatures are present.

The groove region in which there shall be no direct contact between blade root and groove surface in order to prevent or to reduce the heat conduction from the blade or the blade root into the disc encloses at least the entire region that is necessary for the arrangement and for holding the blade in the disc. In particular, the groove region in which a direct contact between blade root and groove surface shall be prevented comprises the region of the bearing surfaces, by way of which the force transfer from the blades onto the disc occurs. Moreover, the groove region, in which a direct contact between blade root and groove surface shall be prevented, can be defined based on the targeted objective, namely, to prevent heat transfer from the blade root into the disc.

According to one embodiment, the entire heat shield element can be formed of a ceramic material.

The heat shield element can be designed as a flat surface element that extends by its lengthwise direction along the lengthwise direction of the groove, and, in a direction crosswise thereto, has a width that extends along the groove surface or the surface of the blade root. In a direction crosswise to both the lengthwise direction and the width direction, the flat surface element has a thickness that is very much smaller, however, than the width or the length.

A flat surface element of this kind can be designed three-dimensionally, so that it is adjacent to the surface of the blade root and/or to the groove surface. Moreover, however, it is also possible that a corresponding flat surface element in the intermediate space between groove surface and surface of the blade root has any desired three-dimensional shape.

The heat shield element may not only be designed as a flat surface element, but it can also comprise a flat surface element, i.e., it may contain other elements in addition to the flat surface element.

The heat shield element or the flat surface element can be designed as a metal-ceramic composite element. In particular, the heat shield element or the flat surface element can be realized as a multi-layer metal-ceramic composite element, wherein the multiple layers can be arranged, in particular, in the thickness direction of the flat surface element or of the heat shield element designed as the flat surface element. For example, the metal-ceramic composite element can be configured as a three-layer element, wherein an inner layer of a ceramic material can be interposed between two outer metal layers. A metal-ceramic composite element of this type can be easily manufactured from a sheet metal or a metal foil by applying a ceramic layer, for example by spraying, and subsequently applying another metal layer.

Moreover, a heat shield element of this type can fulfill additional, different functions. For example, the heat shield element of an embodiment of this type, but also of other design types, in addition to the heat shielding function or to the function of reducing the heat conductivity of the blade root into the disc, can also fulfill the function of matching the shape of the blade root to the groove as well as the function of an element that provides protection from wear.

The heat shield element can be designed as a spacer or can be formed by a plurality of spacers or comprise one or a plurality of spacers. In an advantageous way, the spacers can be formed of a ceramic material, such as, for example, zirconium oxide, and/or can be arranged in the region of the bearing surfaces on which the force transfer is produced from the blade root into the disc, in order to effectively space apart blade root and groove surface.

The one or more spacers can be held by a flat surface element in the gap between blade root and groove surface, wherein the flat surface element can surround the one or more spacers and/or can provide recesses in which the spacers can be held. Additionally or alternatively, the one or more spacers can also be taken up in corresponding recesses on the blade root and/or the disc.

The ceramic material from which the spacers are formed is zirconium oxide or a ceramic material that is based on zirconium oxide, since these materials fulfill the required properties for the desired application in a good way. Correspondingly, zirconium oxide or a material based thereon also finds use as a ceramic material generally in connection with heat shield elements of the type according to the invention, for example, as a ceramic material for metal-ceramic composite elements or for heat shield elements formed completely from ceramic. By way of adjusting as steep as possible a temperature gradient or an appropriate temperature gradient from blade root or from blade to disc, correspondingly, the application temperature for the disc can be kept constant when elevated operating temperature or fluid temperature is present, or when, there is a constant operating temperature or fluid temperature, the application temperature of the disc can be reduced.

### BRIEF DESCRIPTION OF THE DRAWING FIGURES

The appended drawings show in a purely schematic way in:

FIG. 1 is a perspective illustration of a blade, as can find use in the present invention;

FIG. 2 is a sectional view through a first blade-disc arrangement according to the invention;

FIG. 3 is a sectional view, but through a second blade-disc arrangement according to the invention;

FIG. 3a is a detail view of the arrangement of the heat shield element from FIG. 3;

FIG. 4 is a sectional view through a third blade-disc arrangement according to the invention;

FIG. 5 is a sectional view through a fourth blade-disc arrangement according to the invention;

FIG. 6 is a sectional view through a fifth blade-disc arrangement according to the invention; and in

FIG. 6a is a detail view of the arrangement of a spacer in the heat shield element from FIG. 6.

### DESCRIPTION OF THE INVENTION

Further advantages, characteristics and features of the present invention will be clarified in the following detailed description of the examples of embodiment. Of course, the invention is not limited to these exemplary embodiments.

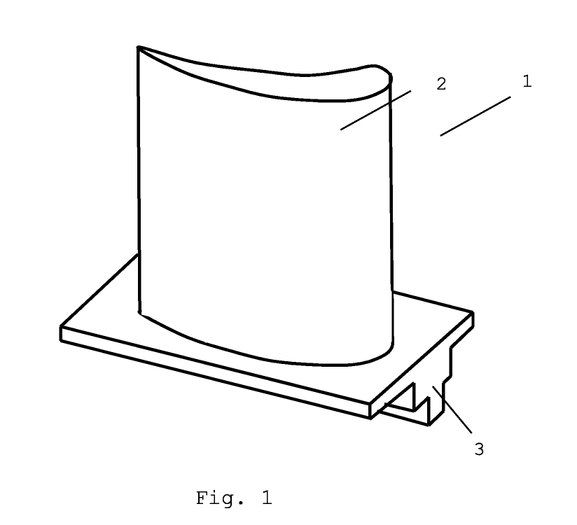

In a perspective illustration, FIG. 1 shows a blade 1 of a turbomachine, such as, for example, a stationary gas turbine or an aircraft engine that can be connected to a disc of the turbomachine. For this purpose, the blade 1 has a blade root 3 that can be introduced into a groove of a disc. Usually, a plurality of blades 1 are arranged by their respective blade roots 3 in a plurality of grooves 5 on the casing surface of a disc, in order to fasten a plurality of blade elements 2 to the disc. As can also be discerned from the following illustrations of the examples of embodiment, the form of the blade root 3 and of a corresponding complementary groove can be executed in any desired, different form, so that the invention is not limited to a special form of the blade root 3.

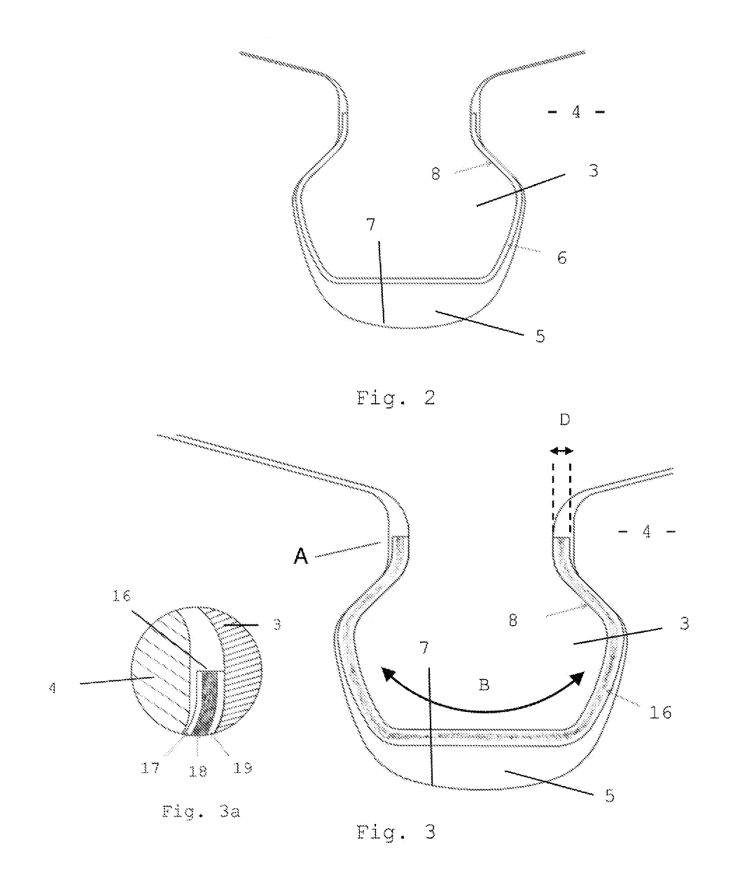

FIG. 2 shows a first exemplary embodiment according to the invention of a blade-disc arrangement in a sectional view, wherein only a portion of the disc 4 with a groove and only a portion of the blade with the blade root 3 are shown. As can be discerned from the illustration of FIG. 2, in the blade-disc arrangement according to the invention, a heat shield element 6, which is adjacent to the surface of the blade root 3 in the exemplary embodiment of FIG. 2, is arranged between the surface 7 of the groove 5 of the disc and the surface of the blade root 3. In particular, the heat shield element 6 extends over the entire surface of the blade root 3, so that in the region of the blade root or of the groove 5, there is no direct contact between the blade or the blade root 3 and the disc 4. Correspondingly, a direct heat transfer from the blade to the disc 4 can be prevented. In particular, the heat shield element 6 is also present in the region of the bearing surface 8, where during operation, the force transfer from the blade to the disc 4 takes place, and a correspondingly intensive contact between blade root 3 and disc 4 would be present. In the exemplary embodiment shown in FIG. 2, the heat shield element 6 is formed of a ceramic material, such as, for example, zirconium oxide, so that, based on the low heat conductivity of the ceramic material or of the zirconium oxide, heat conduction from the blade root 3 into the disc 4 is impeded. At the same time, the ceramic material in the region of the bearing surface 8 makes possible the absorption of pressure loads during operation.

FIG. 3 shows another embodiment of a blade-disc arrangement according to the invention with a heat shield element 16, wherein the embodiment of FIG. 3 differs from that of FIG. 2 only in that the heat shield element 16 has a construction that is different from that of the heat shield element 6. Otherwise, the heat shield element 16, in form and arrangement, is designed corresponding to the heat shield element 6, so that there is no need for a further description thereof.

As can be seen in FIG. 3a, which is a detail view at A of FIG. 3, the heat shield element 16 has a multi-layer construction, wherein the heat shield element 16 is built up from three layers in the exemplary embodiment shown. The three layers of the heat shield element 16 are formed by a first outer metal layer 17 and a second outer metal layer 19, which enclose an inner layer 18 made of a ceramic material.

The heat shield element 16 is designed as a flat surface element, which means that it extends flat along the lengthwise direction of the groove 5, thus perpendicular to the image plane, and crosswise thereto has a width B that extends along the surface of the blade root 3 crosswise to the groove 5, as indicated by the curved double arrow of FIG. 3. Crosswise to both the lengthwise direction and the width direction of the flat heat shield element 16, said element has a thickness D (see the double arrow of FIG. 3), wherein the different layers are arranged along the thickness direction.

The flat heat shield element 16 can be manufactured in a simple way due to the fact that a ceramic layer that forms the inner ceramic layer 18 after fabrication is applied onto a sheet metal or a metal foil that represents the first outer metal layer 17, wherein subsequently, another second outer metal layer 19 in the form of another metal layer can be deposited onto the inner ceramic layer 18. The ceramic material of the inner ceramic layer 18, which can be formed by zirconium oxide, for example, can be applied by thermal spraying, for example.

In a sectional view comparable to FIGS. 2 and 3, FIG. 4 shows a third embodiment of a heat shield element 26 in the form of ceramic spacers that are arranged, in particular, in the region of the bearing surface in recesses 9, 10 on the blade root 3 and the groove 5 of the disc 4, wherein, in the lengthwise direction of the groove 5, the spacer or the heat shield element 26 can be executed as an elongated heat shield element, or a plurality of heat shield elements 26 arranged spaced apart from one another can be provided. As can also be discerned from FIG. 4, corresponding heat shield elements 26 can be provided on two sides of the blade root 3.

Just like the heat shield element 6 of the embodiment of FIG. 2, the heat shield element 26 is formed entirely of a ceramic material, such as zirconium oxide, for example. Of course, it is also possible that the heat shield element 26 is formed of a metal-ceramic composite, for example, by a corresponding multi-layer construction such as in the exemplary embodiment of FIG. 3.

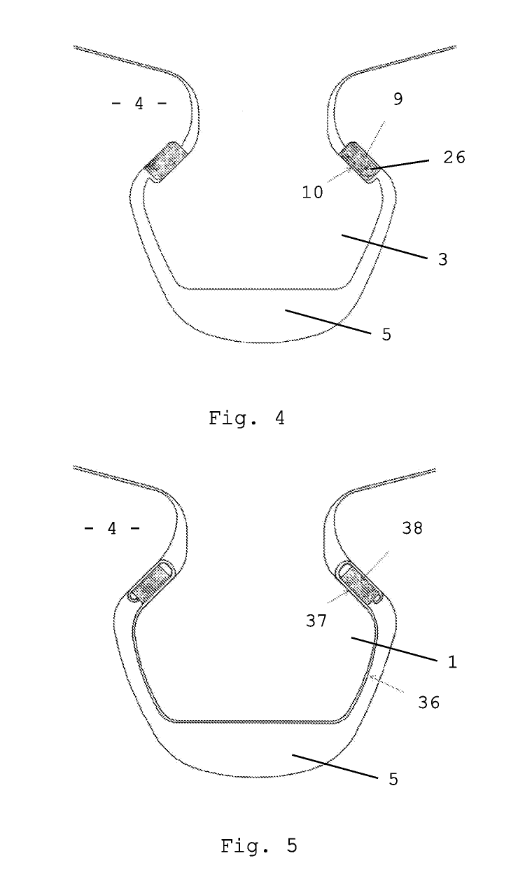

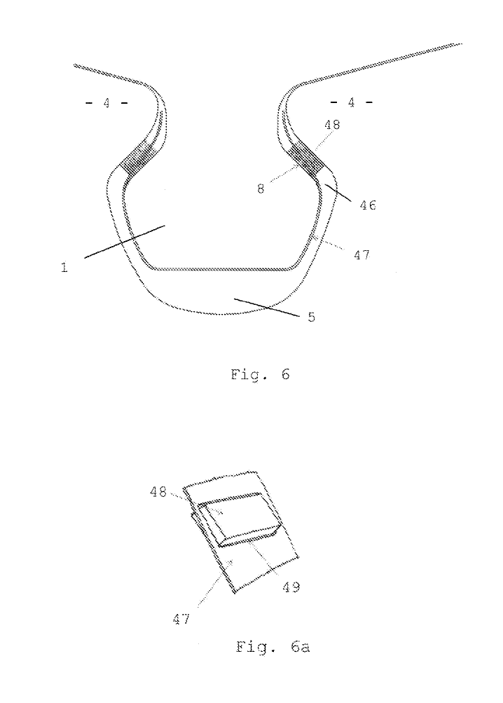

The embodiment examples of FIGS. 5 and 6 show heat shield elements 36 and 46, each composed of a combination of a flat surface element 37, 47 and a spacer 38, 48 made of a ceramic material.

In the case of the embodiment of FIG. 5, the heat shield element 36 is designed so that a metal flat surface element 37, similar to the heat shield elements 6 and 16 of the embodiments of FIGS. 2 and 3, is formed adjacent to the blade root 3, wherein, in the regions of the bearing surfaces 8, the flat surface element 37 is crimped in order to accommodate a ceramic spacer 38 in the crimped regions.

In contrast, the metal flat surface element 47 of the heat shield element 46 of the embodiment of FIG. 6, in the regions of the bearing surfaces 8, has one or a plurality of recesses 49, in which ceramic spacers 48 are accommodated, as can also be discerned, in particular, from the detail view of FIG. 6a. In the embodiment of FIG. 6, just as is the case in the embodiments of FIGS. 4 and 5, only one spacer 48 may be provided in the region of each bearing surface 8, said spacer being able to extend over a wide region of the lengthwise direction of the groove 5, or a plurality of several spacers 48 may be provided, which are distributed at a distance from one another over the length of the groove region.

Although the present invention has been described in detail on the basis of the exemplary embodiments, it is obvious to the person skilled in the art that the invention is not limited to these exemplary embodiments, but rather that modifications are possible in such a way that individual features are omitted or other types of combinations of features can be realized, without leaving the scope of protection of the appended claims. In particular, the present disclosure encompasses all combinations of the individual features shown in the different examples of embodiment, so that individual features that are described only in conjunction with one exemplary embodiment can also be used in other exemplary embodiments, or combinations of individual features that are not explicitly shown can also be employed.

What is claimed is:

1. A blade-disc arrangement for a turbomachine, comprising:
a disc and a plurality of grooves that are arranged in a casing surface of the disc for taking up blades, and a plurality of blades with blade roots that are accommodated in the grooves, wherein
at least one heat shield element is arranged between at least one blade root and a groove surface of at least one groove, so that there is no direct contact between blade root and disc in a groove region, wherein the heat shield element is formed, at least in part, of a ceramic material that is zirconium oxide or is based on zirconium oxide.

2. The blade-disc arrangement according to claim 1, wherein the entire heat shield element is formed of a ceramic material.

3. The blade-disc arrangement according to claim 1, wherein the heat shield element is configured and arranged as a flat surface element extending along the groove or comprises a flat surface element, which has a length along the lengthwise direction of the groove and a width crosswise to the lengthwise direction of the groove along the blade root or the groove surface, and a thickness crosswise to the length and width which is smaller than the length and width of the flat surface element, and wherein the flat surface element is adjacent to a surface of the blade root and/or of the groove surface or has any desired form between the groove surface and the surface of the blade root.

4. The blade-disc arrangement according to claim 1, wherein the heat shield element is configured and arranged as a metal-ceramic composite element, which has a multi-layer construction, preferably a three-layer construction, particularly in the thickness direction, wherein the outer layers of the multi-layer construction are formed of a metal material.

5. The blade-disc arrangement according to claim 1, wherein the heat shield element comprises at least one spacer.

6. The blade-disc arrangement according to claim 5, wherein the at least one spacer is held by the flat surface element, is surrounded by the flat surface element, at least partially, and/or is held in a recess of the flat surface element.

7. The blade-disc arrangement according to claim 1, wherein the at least one heat shield element is taken up in a recess on the blade root and/or the disc.

8. The blade-disc arrangement according to claim 5, wherein the spacer is formed of a ceramic material.

9. The blade-disc arrangement according to claim 1, wherein the at least one heat shield element has a lower heat conductivity than the blade root and/or the disc, so that during operation a temperature gradient is adjusted from the blade root to the disc.

10. The blade-disc arrangement according to claim 3, wherein the flat surface element is configured and arranged as a metal-ceramic composite element, which has a multi-layer construction, preferably a three-layer construction, particularly in the thickness direction, wherein the outer layers of the multi-layer construction are formed of a metal material.

11. The blade-disc arrangement according to claim 5, wherein the at least one spacer is taken up in a recess on the blade root and/or the disc.
